(19) United States
(12) Patent Application Publication
(10) Pub. No.: US 2015/0077681 A1
(43) Pub. Date: Mar. 19, 2015

(54) LIQUID CRYSTAL DISPLAY PANEL

(71) Applicant: Dong Li, Shenzhen (CN)

(72) Inventor: Dong Li, Shenzhen (CN)

(73) Assignee: Shenzhen China Star Optoelectronics Technology Co. Ltd., Shenzhen (CN)

(21) Appl. No.: 13/583,931

(22) PCT Filed: Jun. 11, 2012
(86) PCT No.: PCT/CN12/76687

§ 371 Date: Sep. 11, 2012

(30) Foreign Application Priority Data
May 23, 2012 (CN) 201210162264.8

(51) Int. Cl. G02F 1/13

(52) U.S. Cl. CPC G02F 1/1309
USPC 349/47

(57) ABSTRACT

The present invention provides a liquid crystal display (LCD) panel. The LCD panel comprises a substrate, signal lines, test switches, at least one test line and a control line. The test switches are connected between the signal lines and the test line, and the at least one test line is configured to input test signals to the test switches, and the control line is configured to turn on the test switches. In the present invention, the test line is not required to be cut off by a laser, thereby improving a production capacity and a process yield of the LCD panel.

### FIELD OF THE INVENTION

The present invention relates to a field of a liquid crystal display (LCD) technology, and more particularly to test lines of an LCD panel.

### BACKGROUND OF THE INVENTION

LCDs have been widely applied in electrical products, wherein LCD panels are important components of the LCDs.

After the LCD panels are made, in general, the LCD panels will be tested to find whether the LCD panels have defects to reduce a waste in follow-up processes. Currently, referring to FIG. 1, in the test process of the LCD panels, shorting bars 210 are disposed on an array substrate of the LCD panels and connected to signal lines 220 of the LCD panels. Test signals are inputted to the signal lines 220 through the shorting bars 210 for testing whether the signal lines are broken or have defects. After the test process, the connection between the shorting bars and the signal lines is cut off by a laser.

Since it is necessary to cut off the shorting bars by using the laser after testing the LCD panels, a laser cutting process is required, deteriorating a production capacity and a process yield of the LCD panels.

As a result, it is necessary to provide an LCD panel to solve the problems existing in conventional technologies such as above-mentioned.

### SUMMARY OF THE INVENTION

The present invention provides an LCD panel to solve the test problems existing in conventional LCD panel.

A primary object of the present invention is to provide a liquid crystal display (LCD) panel, and the LCD panel comprises: a substrate; a plurality of signal lines disposed on the substrate; a plurality of test switches connected to the signal lines; at least one test line connected to the test switches configured to input test signals to the test switches; and a control line connected to the test switches and configured to turn on the test switches.

In one embodiment of the present invention, the test switches are thin film transistors (TFTs).

In one embodiment of the present invention, the test switches have source electrodes, drain electrodes and gate electrodes, and the source electrodes are connected to the test line, and the drain electrodes are connected to the signal lines, and the gate electrodes are connected to the control line.

In one embodiment of the present invention, when testing the liquid crystal display panel, a control signal is transmitted to the test switches from the control line, so as to turn on the test switches.

In one embodiment of the present invention, when the signal lines are data lines, a level of the control signal is higher than 8 V

In one embodiment of the present invention, when the signal lines are gate lines, a level of the control signal is higher than 30 V.

In one embodiment of the present invention, the liquid crystal display panel further comprises driving circuit devices disposed on the substrate, wherein the driving circuit devices are electrically connected to the signal lines.

In one embodiment of the present invention, the signal lines have input terminals for receiving the test signals.

In one embodiment of the present invention, an amount of the at least one test line is two, and the two test lines are connected to the test switches, respectively.

In one embodiment of the present invention, an amount of the at least one test line is three, and the liquid crystal display panel has red sub-pixels, green sub-pixels and blue sub-pixels, and the three test lines are configured to test the red sub-pixels, green sub-pixels and blue sub-pixels, respectively.

Another object of the present invention is to provide a liquid crystal display (LCD) panel, and the LCD panel comprises: a substrate; a plurality of signal lines disposed on the substrate; a plurality of test switches connected to the signal lines; at least one test line connected to the test switches configured to input test signals to the test switches; and a control line connected to the test switches and configured to turn on the test switches. When testing the liquid crystal display panel, a control signal is transmitted to the test switches from the control line, so as to turn on the test switches. When the signal lines are data lines, a level of the control signal is higher than 8 V, and when the signal lines are gate lines, a level of the control signal is higher than 30 V.

In the LCD panel of the present invention, the test line is not required to be cut off by the laser, so as to prevent the additional laser cutting process, thereby reducing a process time for manufacturing the LCD panel as well as increasing a production capacity thereof. Therefore, the effect of the laser cutting process on the LCD panel is avoidable for ensuring a process yield of the LCD panels. Moreover, the test switches and active elements of pixels can be formed at the same time without adding additional manufacturing process.

The structure and the technical means adopted by the present invention to achieve the above-mentioned and other objects can be best understood by referring to the following detailed description of the preferred embodiments and the accompanying drawings:

### DESCRIPTION OF THE DRAWINGS

FIG. 1 is a schematic diagram showing a test circuit of a conventional LCD panel;

FIG. 2 is a partially schematic diagram showing an LCD panel according to a preferred embodiment of the present invention;

FIG. 3 is a schematic diagram showing a test circuit of the LCD panel according to the preferred embodiment of the present invention;

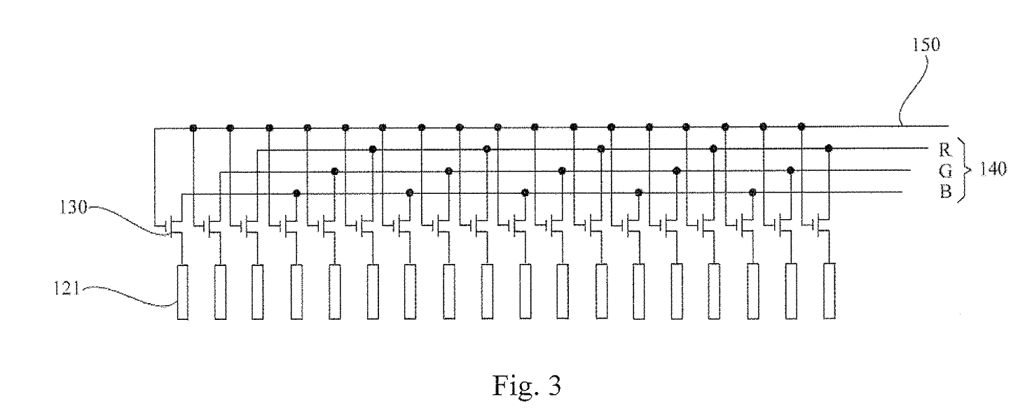

FIG. 4 is a schematic diagram showing a test circuit of the LCD panel according to one embodiment of the present invention; and

FIG. 5 is a schematic diagram showing a test circuit of the LCD panel according to another embodiment of the present invention

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, like reference numerals indicate like components or items.

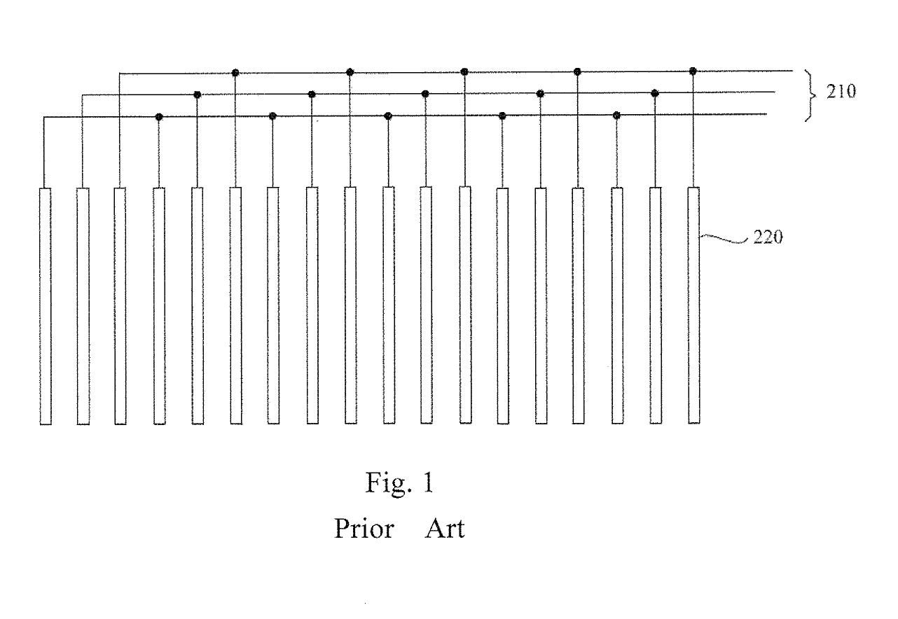

Referring to FIG. 1, a partially schematic diagram showing a liquid crystal display (LCD) panel according to a preferred embodiment of the present invention is illustrated. The LCD panel 100 and a backlight module can be assembled as an LCD apparatus. Referring to FIG. 1 again, the LCD panel 100 of the present embodiment, comprises a substrate 110 which may be a glass substrate or a flexible and plastic substrate. A plurality of signal lines 120, a plurality of test switches 130, at least one test line 140 and a control line 150 are disposed on the substrate 110. The signal lines 120, the test line 140 and the control line 150 are connected to the test switches 130.

Referring to FIG. 1 again, the signal lines 120 may be data lines or gate lines. The signal lines 120 have exposed input terminals 121 for receiving inputted signals, such as scan signals, data signals or test signals. The input terminals 121 are disposed at one side of the signal lines 120 and connected to the test switches 130.

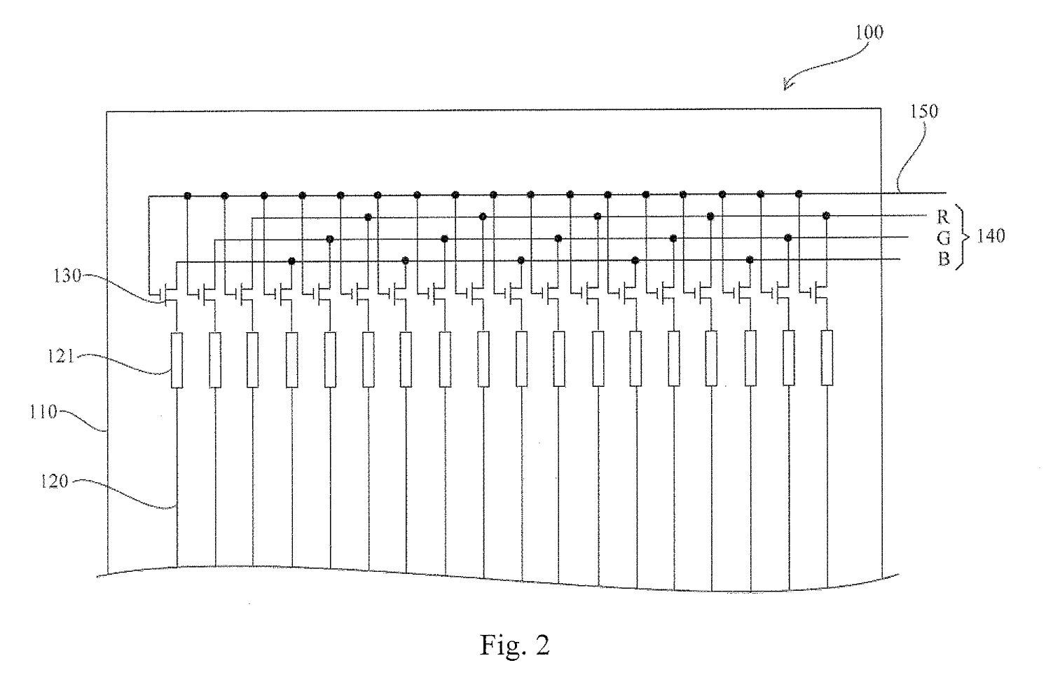

Referring to FIG. 2, a schematic diagram showing a test circuit of the LCD panel according to the preferred embodiment of the present invention is illustrated. The test switches 130 are connected between the input terminals 121 of the signal lines 120 and the test line 140, and can be turned on when testing the LCD panel 100, so as to allow the test signals to be inputted to the signal lines 120. In this embodiment, the test switches 130 may be transistors, such as thin film transistors (TFTs). At this time, the test switches 130 have source electrodes, drain electrodes and gate electrodes (not shown), and the source electrodes are connected to the test line 140, and the drain electrodes are connected to the signal lines 120, and the gate electrodes are connected to the control line 150. Certainly, in this embodiment, the test switches 130 and active elements (such TFTs) of the LCD panel 100 can formed on the substrate 110 at the same time, so as to reduce process steps. That is, in the manufacturing process of the active elements (such TFTs) of the LCD panel 100, the active elements (not shown) and the test switches 130 can be formed on the substrate 110 at the same time, and thus the test switches 130 can be formed without adding additional process steps.

Referring to FIG. 2 again, the at least one test line 140 is connected to the test switches 130 for inputting the test signals to the signal lines 120. An external test unit or system can provide the test signals to the signal lines 120 through the at least one test line 140. In this embodiment, an amount of the at least one test line 140 may be three for testing red sub-pixels (not shown), green sub-pixels (not shown) and blue sub-pixels (not shown) of the LCD panel 100, respectively.

Referring to FIG. 2 again, the control line 150 is connected to the test switches 130 for inputting a control signal to the test switches 130, so as to turn on the test switches 130 when testing the LCD panel 100. The control signal provided from the control line 150 may be a voltage signal of a high level. When the signal lines 120 are the data lines, a level of the control signal is about higher than 8 V, so as to turn on the test switches 130. When the signal lines 120 are the gate lines, a level of the control signal is about higher than 30 V, so as to turn on the test switches 130.

Referring to FIG. 2 again, when testing the LCD panel 100, the test signal can be transmitted to the signal lines 120 through the at least one test line 140. At the same time, the control signal can be transmitted to the test switches 130 through the control line 150, so as to turn on the test switches 130, thereby allowing the test signal to be transmitted to the signal lines 120 through the at least one test line 140 for testing the LCD panel 100.

After testing the LCD panel 100, the input of the control signal to the control line 150 is removed, so as to turn off the test switches 130, and thus the test signal can not be transmitted to the signal lines 120 from the at least one test line 140. Therefore, the path between the at least one test line 140 and the signal lines 120 can be directly turned off by the test switches 130 without using a laser to cut off the test line 140, thereby omitting the additional laser cutting process.

After being tested and the LCD panel 100 is recognized as a normal panel, driving circuit devices (not shown) can be disposed on a non-display region of the substrate 110, i.e. the region around the signal lines 120, for providing signals to the signal lines 120. The driving circuit devices may be source driving circuit or gate driving circuit. At this time, contacts (not shown) of driving circuit devices can be directly bonded to the input terminals 121 of the signal lines 120, and thus the driving circuit devices can be electrically connected to the signal lines 120. After testing the LCD panel 100, the test switches 130 between the signal lines 120 and the at least one test line 140 is in a turned-off state, and thus the driving circuit devices can be directly bonded to the input terminals 121 of the signal lines 120. At this time, the at least one test line 140 is reserved on the LCD panel 100 without being cut off, thereby omitting the additional laser cutting process.

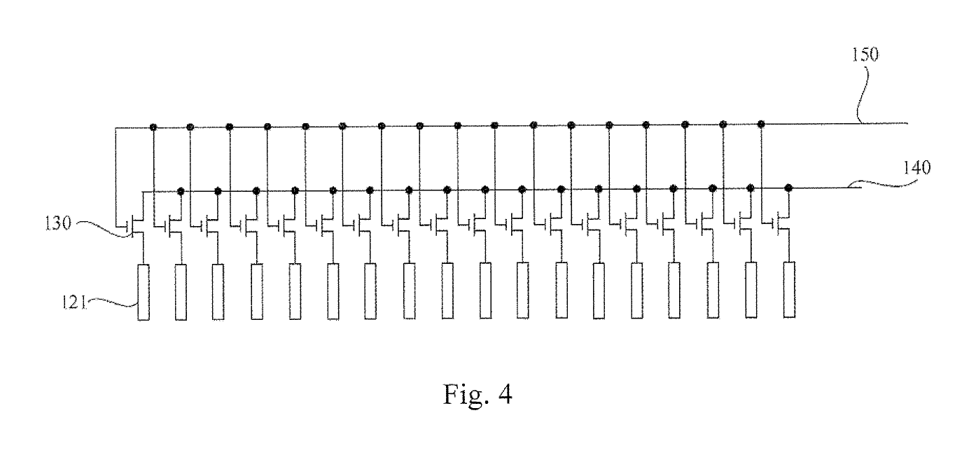

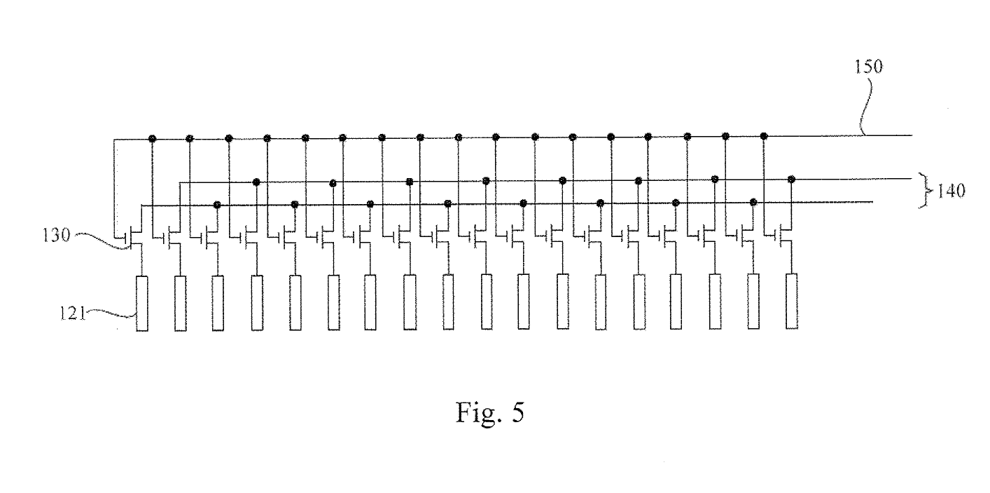

Referring to FIG. 4 and FIG. 5, schematic diagrams showing a test circuit of the LCD panel according to the present invention are illustrated. In one embodiment, referring to FIG. 4, the at least one test line 140 may be one test line connected to the test switches 130 for inputting the testing signals to thereto. In another embodiment, referring to FIG. 5, an amount of the at least one test line 140 may be two, and the two test lines are connected to the test switches 130 for inputting the testing signals to thereto. Certainly, in other embodiment, the at least one test line 140 may be more three test lines.

As described above, in the LCD panel of the present invention, the path between the test line and the signal lines can be selectively turned on/off by the test switches without using the laser to cut off the test line, so as to omit the additional laser cutting process, thereby reducing a process time for manufacturing the LCD panel as well as increasing a production capacity thereof. Therefore, the effect of the laser cutting process on the LCD panel is avoidable for ensuring a process yield of the LCD panels. Moreover, the test switches can be integrated into the manufacturing process of the active elements of pixels without adding additional manufacturing process.

The present invention has been described with a preferred embodiment thereof and it is understood that many changes and modifications to the described embodiment can be carried out without departing from the scope and the spirit of the invention that is intended to be limited only by the appended claims.

1. A liquid crystal display (LCD) panel, comprising:
a substrate;
a plurality of signal lines disposed on the substrate;
a plurality of test switches connected to the signal lines;
at least one test line connected to the test switches configured to input test signals to the test switches; and
a control line connected to the test switches and configured to turn on the test switches;
wherein, when testing the liquid crystal display panel, a control signal is transmitted to the test switches from the control line, so as to turn on the test switches;
wherein, when the signal lines are data lines, a level of the control signal is higher than 8 V, and when the signal lines are gate lines, a level of the control signal is higher than 30 V.

2. The liquid crystal display panel according to claim 1, wherein the test switches are thin film transistors (TFTs).

3. The liquid crystal display panel according to claim 2, wherein the test switches have source electrodes, drain electrodes and gate electrodes, and the source electrodes are connected to the test line, and the drain electrodes are connected to the signal lines, and the gate electrodes are connected to the control line.

4. The liquid crystal display panel according to claim 1, further comprising driving circuit devices disposed on the substrate, wherein the driving circuit devices are electrically connected to the signal lines.

5. The liquid crystal display panel according to claim 1, wherein the signal lines have input terminals for receiving the test signals.

6. The liquid crystal display panel according to claim 1, wherein an amount of the at least one test line is two, and the two test lines are connected to the test switches, respectively.

7. The liquid crystal display panel according to claim 1, wherein an amount of the at least one test line is three, and the liquid crystal display panel has red sub-pixels, green sub-pixels and blue sub-pixels, and the three test lines are configured to test the red sub-pixels, green sub-pixels and blue sub-pixels, respectively.

8. A liquid crystal display (LCD) panel, comprising:
a substrate;
a plurality of signal lines disposed on the substrate;
a plurality of test switches connected to the signal lines;
at least one test line connected to the test switches configured to input test signals to the test switches; and
a control line connected to the test switches and configured to turn on the test switches.

9. The liquid crystal display panel according to claim 8, wherein the test switches are thin film transistors (TFTs).

10. The liquid crystal display panel according to claim 9, wherein the test switches have source electrodes, drain electrodes and gate electrodes, and the source electrodes are connected to the test line, and the drain electrodes are connected to the signal lines, and the gate electrodes are connected to the control line.

11. The liquid crystal display panel according to claim 8, wherein, when testing the liquid crystal display panel, a control signal is transmitted to the test switches from the control line, so as to turn on the test switches.

12. The liquid crystal display panel according to claim 11, wherein, when the signal lines are data lines, a level of the control signal is higher than 8 V

13. The liquid crystal display panel according to claim 11, wherein, when the signal lines are gate lines, a level of the control signal is higher than 30 V.

14. The liquid crystal display panel according to claim 8, further comprising driving circuit devices disposed on the substrate, wherein the driving circuit devices are electrically connected to the signal lines.

15. The liquid crystal display panel according to claim 8, wherein the signal lines have input terminals for receiving the test signals.

16. The liquid crystal display panel according to claim 8, wherein an amount of the at least one test line is two, and the two test lines are connected to the test switches, respectively.

17. The liquid crystal display panel according to claim 8, wherein an amount of the at least one test line is three, and the liquid crystal display panel has red sub-pixels, green sub-pixels and blue sub-pixels, and the three test lines are configured to test the red sub-pixels, green sub-pixels and blue sub-pixels, respectively.
